(19) United States
(12) Patent Application Publication
(10) Pub. No.: US 2013/0113805 A1
(43) Pub. Date: May 9, 2013

(54) Psychological integration state graph display apparatus

(71) Applicant: Tomohiro Tsuta, Kobe (JP)

(72) Inventor: Tomohiro Tsuta, Kobe (JP)

(21) Appl. No.: 13/507,623

(22) Filed: Oct. 3, 2012

(30) Foreign Application Priority Data
Jul. 23, 2011 (JP) 2011-174349

(51) Int. Cl. G06T 11/20

(52) U.S. Cl. 345/440

(57) ABSTRACT

An apparatus for displaying psychological integrity state graph, including: a transition graph screen generating means; an input trial number variable initialization means; a first elapsed time storing means; an input detecting means; a second elapsed time storing means; an input time interval calculation means; an input trial number storing means; an input time interval plotting means; and a transition graph plotting means.

### BACKGROUND OF THE INVENTION

The present invention relates to a psychological integrity state graph display apparatus.

There is no apparatus for displaying psychological integrity state graph.

Nonpatent literature 1: “The latest comprehensive dictionary of medical science”, Ishiyaku Publishers Inc., 1987, 1990.

An aim of the present invention is to provide a psychological integrity state graph display apparatus.

### SUMMARY OF THE INVENTION

To achieve the above aim, the invention of claim 1 is an apparatus for displaying psychological integrity state graph, including:

means for generating a transition graph screen to plot a transition graph on an output device;

means for initializing the value of an input trial number variable that stores input trial number, at 0, and storing it on a memory device;

means for obtaining an elapsed time since operating system activation as a first elapsed time to be stored on a memory device;

means for, when said first elapsed time is obtained and stored via said first elapsed time storing means, waiting until a moment of an input to an input device is detected;

means for, when said moment of the input to said input device is detected via said input detecting means, obtaining an elapsed time since operating system activation as a second elapsed time to be stored on a memory device;

means for reading out from the memory device said first elapsed time stored via said first elapsed time storing means, reading out from the memory device said second elapsed time stored via said second elapsed time storing means, subtracting the value of said first elapsed time from the value of said second elapsed time via calculation of an arithmetic unit, and storing it on the memory device as an input time interval;

means for, when said moment of the input to said input device is detected via said input detecting means, incrementing by one via the arithmetic unit the value of said input trial number variable that stores input trial number, and storing it on the memory device;

means for reading out from the memory device said input trial number stored by said input trial number storing means, reading out from the memory device said input time interval calculated and stored by said input time interval calculation means with respect to said input trial number, and plotting said input time interval that corresponds to said input trial number on said transition graph screen generated by said transition graph screen generating means based on the value of said input trial number and the value of said input time interval;

and means for generating time series of said input time interval with respect to said input trial number by iterating means from said first elapsed time storing means onward similarly, and plotting it on said transition graph screen generated by said transition graph screen generating means as transition graph of said input time interval.

The invention of claim 2 is the apparatus for displaying psychological integrity state graph of claim 1, further including:

means for attaching the information on psychological integrity state of a subject based on the result of said psychological integrity state graph display apparatus that is used by the subject before conducting another experiment, to the result of said experiment, as the information that closely and precisely reflects the psychological integrity state of said subject at the time of said experiment.

The invention of claim 3 is a method for the psychological integrity state graph display apparatus of claim 1 for effecting instantaneous alteration and enhancement of psychological integrity state to a feasible, maximum degree, further including:

a step of means for displaying, on an output device, a symbol to be gazed at by a subject that flickers at a frequency less than but nearing a flicker fusion frequency;

a step of means for activating said psychological integrity state graph display apparatus of claim 1 while advising said subject to start inputs to said input device in succession immediately after a momentary time period from the start of the display of said symbol, said momentary time period being set as a period within which the subject does not develop adaptational saturation to said symbol.

### BRIEF DESCRIPTION OF THE DRAWINGS

FIG. 1 is a diagram showing a preferred embodiment of the present invention.

FIG. 2 is a diagram showing a preferred embodiment of the present invention.

FIG. 3 is a diagram showing a preferred embodiment of the present invention.

FIG. 4 is a diagram showing a preferred embodiment of the present invention.

FIG. 5 is a diagram showing a preferred embodiment of the present invention.

FIG. 6 is a diagram showing a preferred embodiment of the present invention.

### DETAILED DESCRIPTION OF THE INVENTION

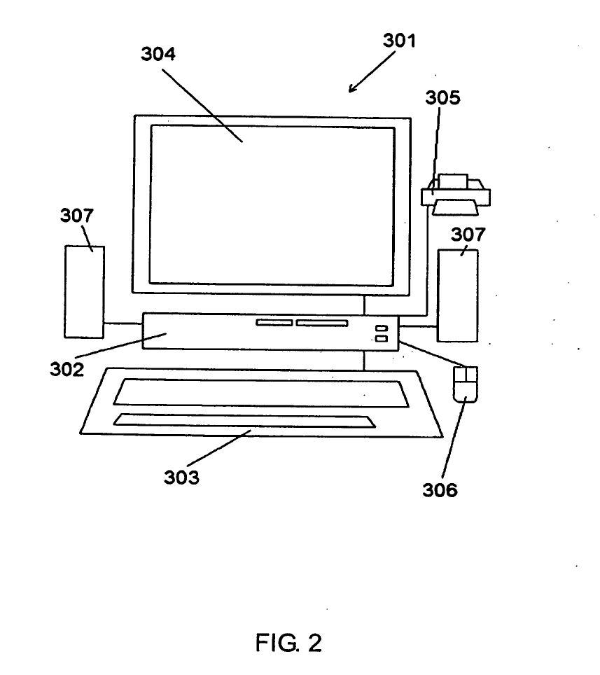

FIG. 2 shows a computer system 301 diagrammatically. The present invention is realized by the computer system 301 carrying out a program for realizing the invention. As shown in FIG. 2, the computer system 301 realizing an embodiment of the present invention includes a main unit 302 that is equipped with a CPU (Central Processing Unit) 501, etc., which will be mentioned later, a keyboard 303, (if necessary a mouse 306,) a display 304, (a printer 305) (and if necessary, a speaker 307).

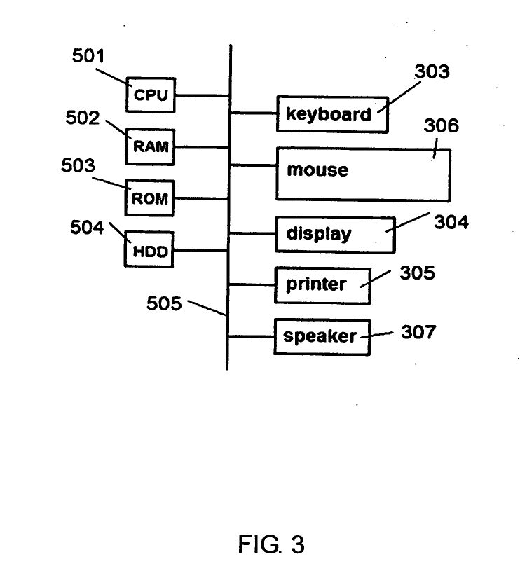

Next, an embodiment of the hardware configuration of the CPU 501 in the present invention is described referring to FIG. 3.

The CPU 501 in the present invention is configured specifically including: a microprocessor such as the CPU 501, a RAM (Random Access Memory) 502, a ROM (Read Only Memory) 503, a HDD (Hard Disc Drive) 504, a keyboard 303, (a mouse 306,) a display 304, (a printer 305,) (a speaker 307,) (and a communications interface). These parts are connected via a bus 505.

The CPU 501 carries out operations characteristic of an embodiment of the present invention, by loading onto the RAM 502 a program which is stored in the HDD (Hard Disc Drive) 504 for realizing the present invention.

The CPU 501 carries out controls, and kinds of arithmetic processing, of the present invention, according to a program for realizing the present invention. The CPU 501 controls display processing of the display 304 (an example of the output device). The CPU 501 controls the present invention according to input by the keyboard 303 (an example of the input device). The CPU 501 may control the printer 305 and the like so as to output an image that is generated based on the data obtained from the present invention.

The keyboard 303 (and if necessary, the mouse 306) and the display 304 are used as user interfaces in the present invention. The keyboard 303 is used, for example, as a device for input (the input device).

The display 304 is a display device (the output device), for example, of a LCD (Liquid Crystal Display), (an OLED (Organic Light-Emitting Diode)), a CRT (Cathode Ray Tube), or the like.

And when the CPU 501 is connectable to communications network such as the Internet and a LAN (Local Area Network), the communications interface can be equipped with a network adapter such as a LAN card or communications equipment such as a modem in order to establish data communication among the network. In such a case, by installing on the network a server storing a program for realizing the present invention, and configuring the CPU 501 as a client terminal of the server, the operation of the present invention can be carried out by the client terminal.

A program for realizing the present invention can be stored on any computer-readable non-transitory media (storage media). Examples of such non-transitory media (storage media) include an optical disk, a magneto-optic disk (CD-ROM, DVD-RAM, DVD-ROM, MO, etc.), a magnetic-storage device (hard disk, Floppy Disk™, ZIP, etc.), a semiconductor memory, etc.

Next, the detailed explanation regarding the present invention, operational method of the present invention, and program for realizing the present invention will be described.

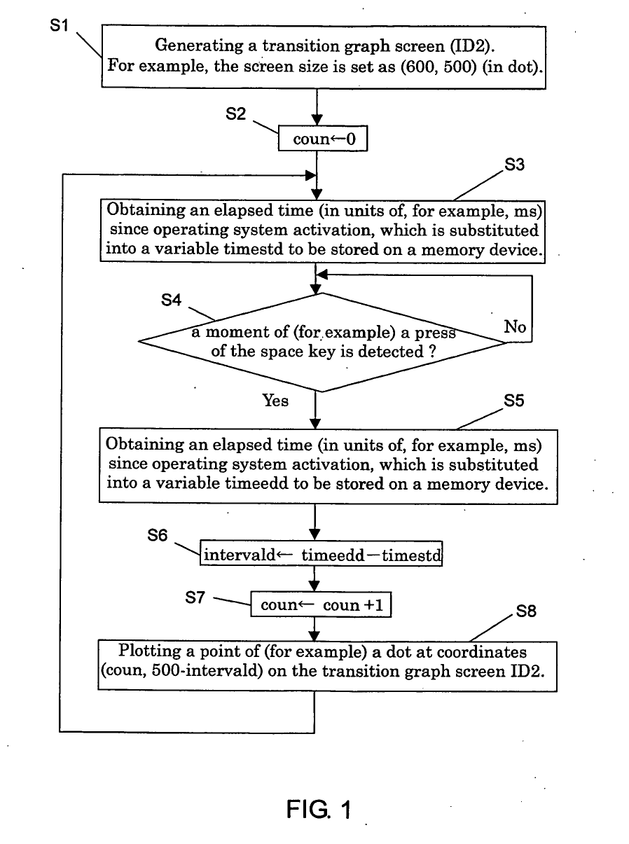

Referring to FIG. 1,

in the first invention of the present invention,

at S1, the CPU 501 generates a transition graph screen (ID2) to plot a transition graph on an output device (a transition graph screen generating means). For example, the screen size is set as (600, 500) (in dot) (in units of pixel).

On the transition graph screen ID2, scale lines and reference lines to indicate standard values, etc. may be plotted to facilitate the analysis and interpretation of the displayed results.

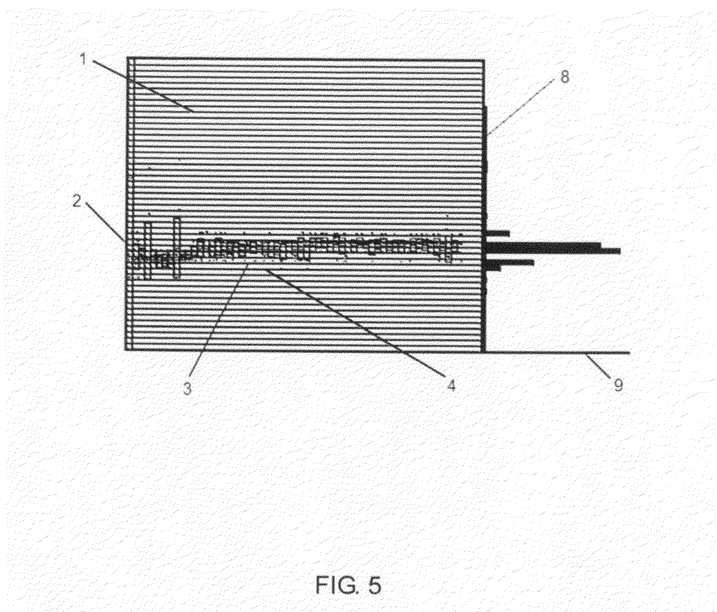

For example, in FIG. 5, a scale line 1 is plotted with 10 ms spacing with respect to a time axis 2.

A standard reference line 3 is, for example, at 150 ms with respect to time axis 2.

A standard reference line 4 is, for example, at 140 ms with respect to time axis 2.

The 150 ms and 140 ms are related to the (lower limiting) value of the time observed by the present invention when a subject's psychological integrity state is in (relatively) high level.

At S2, the CPU 501 initializes the value of an input trial number variable (coun) that stores input trial number, at 0, and stores it on a memory device (an input trial number variable initialization means).

At S3, the CPU 501 obtains an elapsed time (in units of, for example, ms) since operating system activation as a first elapsed time, which is substituted into a variable timestd to be stored on a memory device (a first elapsed time storing means).

At S4, the CPU 501, when said first elapsed time is obtained and stored via said first elapsed time storing means at S3, waits until a moment of (for example) an input to an input device is detected (an input detecting means).

(For example, the CPU 501 waits until a moment of an input to, for example, the space key (or another key may be used) of a keyboard 303 is detected.)

(In the case of readily realizing the present invention on the computer, etc., for example, the subject is advised to repetitively press (with a maximum speed (or with a practicable (attainable) speed for the subject)) (using, for example, the index finger of the dominant hand (finger other than the index finger may be used (comparison with the result of other finger may be made)) (the hand other than the dominant hand may be used (comparison with the result of the hand other than the dominant hand may be made))) a (the same) key (for example, the space key on the computer (or other key may be used)) on a keyboard (in succession (or in rapid succession)) (the number of times of the repetition and the measuring time may be set (the limit of the number of times of the repetition (input trial number) may be set, for example, at about 600 trials, or may be set at other number)), and the present invention measures via an arithmetic unit the time required in each trial (each space key press movement) (for example, an input time interval) which is stored on a memory device and (by reading out the memory) displays graph, for example, in time series (on a computer display).)

At S5, the CPU 501, when said moment of the input to said input device is detected via said input detecting means at S4, obtains an elapsed time (in units of, for example, ms) since operating system activation as a second elapsed time, which is substituted into a variable timeedd to be stored on a memory device (a second elapsed time storing means).

At S6, the CPU 501 reads out from the memory device said first elapsed time (timestd) stored via said first elapsed time storing means at S3, reads out from the memory device said second elapsed time (timeedd) stored via said second elapsed time storing means at S5, subtracting the value of said first elapsed time from the value of said second elapsed time via calculation of an arithmetic unit, and stores it on the memory device as an input time interval (intervald) (an input time interval calculation means).

At S7, the CPU 501, when said moment of the input to said input device is detected via said input detecting means at S4, increments by one via the arithmetic unit the value of said input trial number variable (coun) that stores input trial number, and stores it on the memory device (an input trial number storing means).

(The input trial number variable may be a (more temporal, time series-like) variable, for example, based on the elapsed time from the start of the measurement by the present invention.)

At S8, the CPU 501 reads out from the memory device said input trial number (coun) stored by said input trial number storing means (at S7), reads out from the memory device said input time interval (intervald) calculated and stored by said input time interval calculation means (at S6) corresponding to said input trial number, and plots said input time interval that corresponds to said input trial number on said transition graph screen (ID2) generated by said transition graph screen generating means based on the value of said input trial number and the value of said input time interval (an input time interval plotting means).

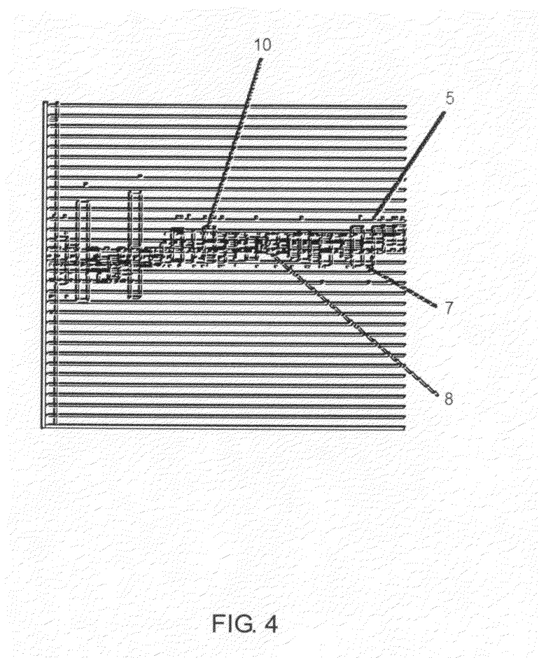

The CPU 501 plots a point of (for example) a dot at coordinates (coun, 500-intervald) on the transition graph screen ID2. (For example, a point 5 in FIG. 4.) A (positional) representation in more visually perceivable form may be applied.

(In coordinates representation such as (coun, 500-intervald), the positions are described assuming that the position of the upper left corner of the transition graph screen ID2 shall be at x coordinate of 0 dot and y coordinate of 0 dot, and x coordinate axis shall be generated rightward from the upper left corner of the screen and a y coordinate axis shall be generated downward from the upper left corner of the screen.)

The plotting may be in other form such as bar graph, etc.

After S8, the CPU 501 goes back to S3, continuing the processing.

That is, the CPU 501 generates time series of said input time interval with respect to said input trial number by iterating means from said first elapsed time storing means (S3) onward similarly, and plotting it on said transition graph screen generated by said transition graph screen generating means, as transition graph of said input time interval (a transition graph plotting means).

The time series (through repetitive movements) of time required in one movement (component) in repetitive movements obtained by the present invention reflects the subject's psychological integrity state (the degree of concentration, the degree of influence of a load (afterimage) on the subject, etc.) at the time of measurement by the present invention (, which is, if the subject had engaged in some information processing (information reception) in a temporal proximity to the measurement, inertially influenced (shift in recollection velocity, information processing pressure generation) by a psychological integrity state brought about (adaptively) by that information processing (information reception).

A ten input trial number mean input time interval graph plotting 6 may be plotted as in FIG. 4, which indicates (each) mean value of input time intervals per (successive) ten input trials (in time series).

A two input trial number mean input time interval graph plotting 7 may be plotted as in FIG. 4, which indicates (each) mean value of input time intervals per (successive) two input trials (in time series).

An upper and lower standard deviation rectangles 10 may be plotted as in FIG. 4, which indicates (each) upper and lower standard deviation per (for example) (successive) ten input trials (in time series).

The time series (the transition graph of said input time interval) may be integrally projected into a frequency axis 9 with respect to a time bin axis 8, as in FIG. 5.

The apparatus for displaying psychological integrity state graph of claim 1, further comprising means for attaching the information on psychological integrity state of a subject based on the result of said psychological integrity state graph display apparatus that is used by the subject before conducting another experiment, to the result of said experiment, as the information that closely and precisely reflects the psychological integrity state of said subject at the time of said experiment. (A psychological integrity state information attachment means.)

The psychological integrity state of the subject at the time of said experiment can be (objectively and precisely) (closely) known (referenced) afterwards when the result of said (perception, cognizance, motor) experiment is examined.

For example, it becomes easily confirmed using the (present invention) graph whether the subject's psychological integrity states were constant between said experiments conducted at different time points.

By attaching the result such as the graph obtained by the present invention to the result of said experiment, each experiment result at different time point can be compared each other including (considering) the subject's psychological integrity states.

(By using the present invention in combination with fmri, It may become possible to map brain regions (involved) relevant to the subject's psychological integrity state, less integrity, fluctuation, psychological integrity increase, stabilization, etc. measured (plotted) by the present invention.)

(The present invention may be used as a method for evaluating the quality of what has been perceived (sensed) by the subject before (immediately before) the measurement of the present invention (or during measurement by the present invention), based on said time series measured by the present invention.)

There are cases where the subject's psychological integrity level can be increased (or stabilized) by the use of the present invention (or e.g., when using the present invention while observing the graph (transition) drawn by the present invention).

There are (many) cases where the psychological integrity states (level) increased by (the use of) the present invention can be inertially transferred validly to other information (reception) processing (activity) to be utilized as (afterimage like) inertia ((very effective and enduring) propulsive force) (facilitator).

In the case of realizing the present invention on the computer, etc., a fixation image may be displayed on the display to be gazed at by the subject who uses the present invention.

(Then, the present invention may further include means for changing display aspect of said fixation image, in order to observe the influence of said fixation image display aspect on said subject's psychological integrity state.)

(The present invention may further include means for changing view point location (fixation image position), in order to make observable the influence of the view point location of said subject (fixation image position) on said subject's psychological integrity state.)

(Or in order to make observable the influence of the visual information displayed upon said subject's psychological integrity state, the present invention may further include means for changing said visual information on the display.)

(In order to display and analyze more detailed component element of the time (the time required in one movement in repetitive movements) (e.g., said input time interval) obtained by the present invention, the psychological integrity state graph display apparatus of the present invention may further include:

means for, in FIG. 1, as S5.1 after S5, (the CPU501) waiting until (for example) a space key press is released;

(if (for example) the space key press is judged to be released at S5.1, the CPU501 moves on to S5.2,)

means for, as S5.2, (the CPU501) obtaining an elapsed time since operating system activation (e.g., in ms) which is substituted into a variable timeedd66 to be stored on the memory device;

means for, as S6.1 after S6, (the CPU501) carrying out a computation of time660d=timeedd66-timeedd (a computation of time660d=timeedd66-timestd may be carried out) via the arithmetic unit to be stored on the memory device;

and (moving on to S7 after S6.1,) means for, as S8.1 after S8, plotting a point of (for example) a dot at coordinates (coun, 500-time660d) on the transition graph screen ID2.)

A method for (bringing about) instantaneous alteration (enhancement) of psychological integrity state to a (feasible) maximum degree, comprising:

a step of means for displaying, on an output device, a symbol to be gazed at by a subject which flickers at a frequency less than but nearing a (flicker) fusion frequency;

a step of means for urging (advising) the subject to start very simple repetitive movements (immediately) after a momentary time period from the start of the display of said symbol, said momentary time period being set as a period within which the subject does not develop adaptational saturation to said symbol.

A psychological integrity state graph display apparatus of claim 1 for effecting instantaneous alteration (enhancement) of psychological integrity state to a (feasible) maximum degree, further comprising:

a step of means for displaying, on an output device, a symbol to be gazed at by a subject that flickers at a frequency less than but nearing a (flicker) fusion frequency;

a step of means for activating said psychological integrity state graph display apparatus of claim 1 while advising the subject to start inputs to said input device in succession (immediately) after a momentary time period from the start of the display of said symbol, said momentary time period being set as a period within which the subject does not develop adaptational saturation to said symbol.

(in terms of the possibility of exerting an influence (strong influence) on the frequency of the subject's repetitive movements by the frequency visually perceived by the subject, and effectively transferring the visually perceived frequency to the repetitive movement frequency of the subject (which reflects the subject's psychological integrity state).)

Said very simple repetitive movements may be, for example, successive presses by the subject of a key (e.g. the space key) on the computer.

The inputs to said input device may, for example, be successive presses by the subject of a key (e.g. the space key) on the computer.

Said symbol may, for example, be made of an asterisk.

Specifically, the said frequency at which said symbol flickers may be set at 12 Hz.

The asterisk may be alternated from red to black on the background color of black (with (about) 12 Hz (with the black period (about 41 ms) and the red period (about 41 ms))).

Said momentary time period may be set at a value between, for example, from 1 to 4 seconds (within which the subject would not develop adaptational saturation to said symbol).

Specifically, said momentary time period may be set at 1.5 second.

Specifically, said momentary time period may be set at 2.5 second.

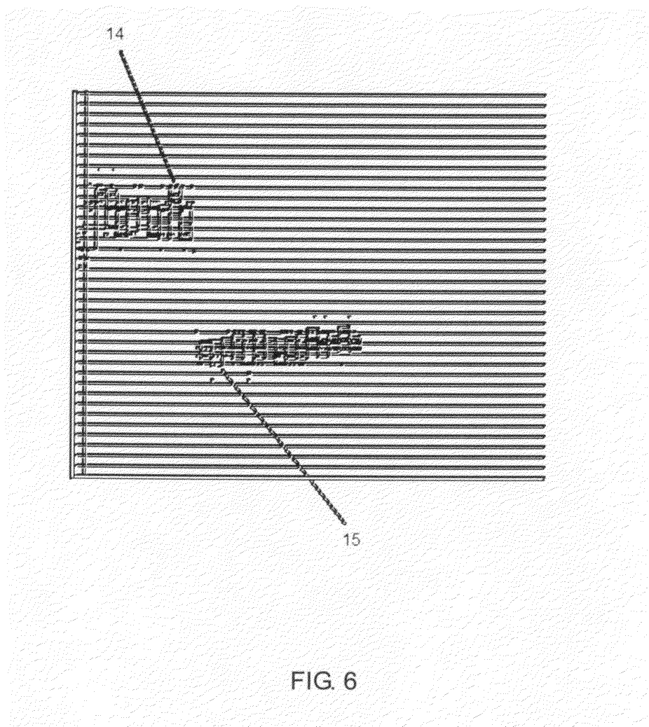

FIG. 6 shows an example of the decisive alteration of psychological integrity state instantaneously brought about by the present invention of claim 3, as enhancement of psychological integrity state from low integrity state (a transition graph before the use of claim 3 of said input time interval 14) to (extremely) high integrity state (a transition graph after the use of claim 3 of said input time interval 15).

What is claimed is:

1. An apparatus for displaying psychological integrity state graph, comprising:
means for generating a transition graph screen to plot a transition graph on an output device;
means for initializing the value of an input trial number variable that stores input trial number, at 0, and storing it on a memory device;
means for obtaining an elapsed time since operating system activation as a first elapsed time to be stored on a memory device;
means for, when said first elapsed time is obtained and stored via said first elapsed time storing means, waiting until a moment of an input to an input device is detected;
means for, when said moment of the input to said input device is detected via said input detecting means, obtaining an elapsed time since operating system activation as a second elapsed time to be stored on a memory device;
means for reading out from the memory device said first elapsed time stored via said first elapsed time storing means, reading out from the memory device said second elapsed time stored via said second elapsed time storing means, subtracting the value of said first elapsed time from the value of said second elapsed time via calculation of an arithmetic unit, and storing it on the memory device as an input time interval;
means for, when said moment of the input to said input device is detected via said input detecting means, incrementing by one via the arithmetic unit the value of said input trial number variable that stores input trial number, and storing it on the memory device;
means for reading out from the memory device said input trial number stored by said input trial number storing means, reading out from the memory device said input time interval calculated and stored by said input time interval calculation means with respect to said input trial number, and plotting said input time interval that corresponds to said input trial number on said transition graph screen generated by said transition graph screen generating means based on the value of said input trial number and the value of said input time interval;
and means for generating time series of said input time interval with respect to said input trial number by iterating means from said first elapsed time storing means onward similarly, and plotting it on said transition graph screen generated by said transition graph screen generating means as transition graph of said input time interval.

2. The apparatus for displaying psychological integrity state graph of claim 1, further comprising:
means for attaching the information on psychological integrity state of a subject based on the result of said psychological integrity state graph display apparatus that is used by the subject before conducting another experiment, to the result of said experiment, as the information that closely and precisely reflects the psychological integrity state of said subject at the time of said experiment.

3. A method for the psychological integrity state graph display apparatus of claim 1 for effecting instantaneous alteration and enhancement of psychological integrity state to a feasible, maximum degree, further comprising:
a step of means for displaying, on an output device, a symbol to be gazed at by a subject that flickers at a frequency less than but nearing a flicker fusion frequency;
a step of means for activating said psychological integrity state graph display apparatus of claim 1 while advising the subject to start inputs to said input device in succession immediately after a momentary time period from the start of the display of said symbol, said momentary time period being set as a period within which the subject does not develop adaptational saturation to said symbol.
